(19) United States
(12) Patent Application Publication
(10) Pub. No.: US 2011/0163574 A1
(43) Pub. Date: Jul. 7, 2011

(54) Automatically Adjustable Head Restraint

(76) Inventors: Omar D. Tame, West Bloomfield, MI (US); Imtiyaz Syed, West Bloomfield, MI (US)

(21) Appl. No.: 12/599,190

(22) PCT Filed: May 6, 2008
(86) PCT No.: PCT/CA08/01028

§ 371 Date: Nov. 6, 2009

Related U.S. Application Data
(60) Provisional application No. 60/916,630, filed on May 8, 2007.

(51) Int. Cl. B60N 2/48; B60N 2/22

(52) U.S. Cl. 297/61

(57) ABSTRACT

A vehicle seat assembly includes a seat cushion and seat back for supporting a seat occupant. The seat back is operatively coupled to the seat cushion for selective pivotal movement between a plurality of reclined seating positions. The seat back includes a seat back frame. A head restraint is coupled to the seat back frame and defines a backset distance between the head restraint and the seat occupant's head. A mechanism operatively interconnects the seat back frame and the seat cushion for automatically tilting the seat back in response to pivotally adjusting the seat back in order to maintain the backset distance constant. When the seat back pivots rearward the seat back tilts forward, moving the head restraint toward the seat occupant's head. When the seat back pivots forward the seat back tilts rearward, moving the head restraint away from the seat occupant's head.

### BACKGROUND OF THE INVENTION

1. Field of the Invention

The invention relates to seat assemblies for an automotive vehicle. More particularly, the invention relates to a mechanism for automatically adjusting the position of a head restraint in response to pivotal movement of a seat back relative to a seat cushion.

2. Description of Related Art

Automotive vehicles include seat assemblies for supporting an occupant in the vehicle. The seat assemblies include a seat cushion and a seat back. Typically, the seat back is pivotally coupled to the seat cushion by a recliner mechanism to allow for pivotal movement of the seat back between a plurality of reclined seating positions. Each reclined seating position corresponds to a particular seat back recline angle.

The seat assemblies also commonly include a head restraint which provides added comfort for the seat occupant's head. In addition to the comfort feature, the head restraint also provides a safety feature. Namely, the head restraint provides needed head support during rear end collisions which reduces the likelihood of whiplash type injuries. Typically, the head restraint is one of three types. The first type is an “integral” head restraint, which is formed as part of a top portion of the seat back and is non-adjustable. The second type is an “adjustable” head restraint, which consists of a separate cushion that is mounted to the top portion of the seat back and includes some type of height adjustment mechanism to provide vertical adjustment of the head restraint to accommodate seat occupants of varying heights. Some adjustable head restraints also provide horizontal adjustment to allow the head restraint to be moved closer to or farther away from the seat occupant's head. The third type is an “active” head restraint, which deploys toward the seat occupant's head in the event of a collision to minimize the potential for whiplash.

The National Highway Traffic Safety Administration recently revised Federal Motor Vehicle Safety Standard (FMVSS) 202, which governs head restraints. The new standard, known as FMVSS 202a, establishes a requirement for the fore-aft position of the head restraint. Basically, a fore-aft distance between the head restraint and the back of the seat occupant's head should not exceed fifty-five (55) millimeters when measured with an occupant torso angle of twenty five (25) degrees. This fore-aft distance is commonly referred to as “backset.”

One problem with the previously mentioned types of head restraints is the head restraint moves with the seat back during adjustment of the seat back between the plurality of reclined seating positions. Therefore, if the seat assembly is designed with a backset distance of 55 millimeters when the occupant torso angle is at 25 degrees, as the seat back is pivoted forward toward a more upright seating position the head restraint will move closer to the seat occupant's head, potentially creating discomfort for the occupant. The reverse occurs when the seat back is pivoted rearward toward a more reclined seating position, i.e., the head restraint will move farther away from the seat occupant's head. Alternatively, if the seat assembly is designed with a backset distance of 55 millimeters when the seat back is in an upright seating position, as the seat back pivots rearward the head restraint will move farther away from the seat occupant's head and potentially create discomfort for the occupant.

Therefore, there is a need to provide a mechanism for automatically adjusting the position of a head restraint in response to pivotal movement of a seat back to maintain a specified distance between the head restraint and a seat occupant's head to minimize potential occupant discomfort.

### SUMMARY OF THE INVENTION

According to one aspect of the invention, a seat assembly is provided for supporting a seat occupant in an automotive vehicle. The seat assembly includes a seat cushion and a seat back operatively coupled to the seat cushion for selective pivotal movement of the seat back relative to the seat cushion between a plurality of reclined seating positions. The seat back includes a seat back frame. A head restraint is coupled to the upper end of the seat back frame and includes a front surface for supporting a head of the seat occupant. A backset distance is defined between the front surface of the head restraint and the seat occupant's head. An adjustment mechanism operatively interconnects the seat back frame and the seat cushion for automatically tilting the seat back in response to pivotally adjusting the seat back in order to maintain the backset distance. As the seat back pivots rearward the seat back tilts forward thereby moving the head restraint toward the seat occupant's head. As the seat back pivots forward the seat back tilts rearward thereby moving the head restraint away from the seat occupant's head.

In one embodiment of the invention, the adjustment mechanism includes a pair of eccentric bearings operatively coupled between the seat back and seat cushion. Rotation of the eccentric bearings in response to pivotally adjusting the seat back translates a lower end of the seat back forwardly and rearwardly along an arcuate path thereby tilting the seat back to maintain the backset distance between the front surface of the head restraint and the seat occupant's head constant.

In another embodiment of the invention, the adjustment mechanism includes a pair of V-shaped links in place of the eccentric bearings. The V-shaped links are operatively coupled between the seat back and seat cushion. Rotation of the V-shaped links in response to pivotally adjusting the seat back translates the lower end of the seat back forwardly and rearwardly along the arcuate path thereby tilting the seat back to maintain the backset distance between the front surface of the head restraint and the seat occupant's head constant.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 is a side view of a seat assembly including a seat back in an upright seating position and an adjustment mechanism for tilting the seat back according to the invention;

FIG. 2 is a side view of the seat assembly with the seat back in a reclined seating position with an upper end of the seat back tilted forward;

FIG. 3 is a fragmentary, perspective view of the seat assembly with the seat back in the upright seating position;

FIG. 4 is a fragmentary, perspective view of the seat assembly with the seat back in the reclined seating position;

FIG. 5 is an exploded, perspective view of the adjustment mechanism;

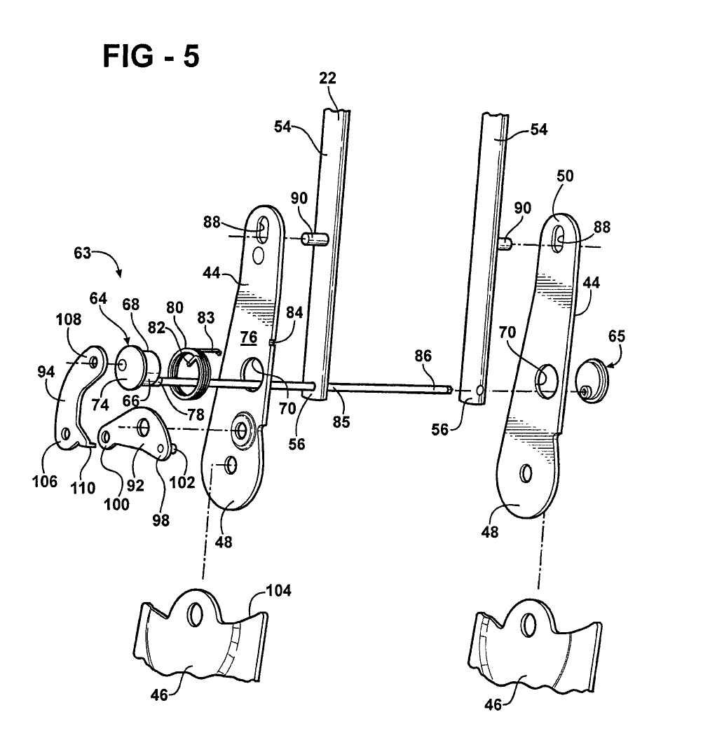

FIG. 6 is a cross-sectional view taken along lines 6-6 of FIG. 1;

FIG. 7 is a fragmentary, perspective view of the seat assembly including a non-linear tab for actuating the adjustment mechanism;

FIG. 8 is a side view of a seat assembly including a seat back in an upright seating position and an adjustment mechanism for tilting the seat back according to a second embodiment of the invention;

FIG. 9 is a side view of the seat assembly of FIG. 8 with the seat back in a reclined seating position with an upper end of the seat back tilted forward;

FIG. 10 is a fragmentary, side view of the seat assembly of FIG. 8 with the seat back in the upright seating position;

FIG. 11 is a fragmentary, side view of the seat assembly of FIG. 9 with the seat back in the reclined seating position;

FIG. 12 is a fragmentary, perspective view of the seat assembly of FIG. 8; and

FIG. 13 is an exploded view of FIG. 12.

### DETAILED DESCRIPTION OF THE EMBODIMENTS

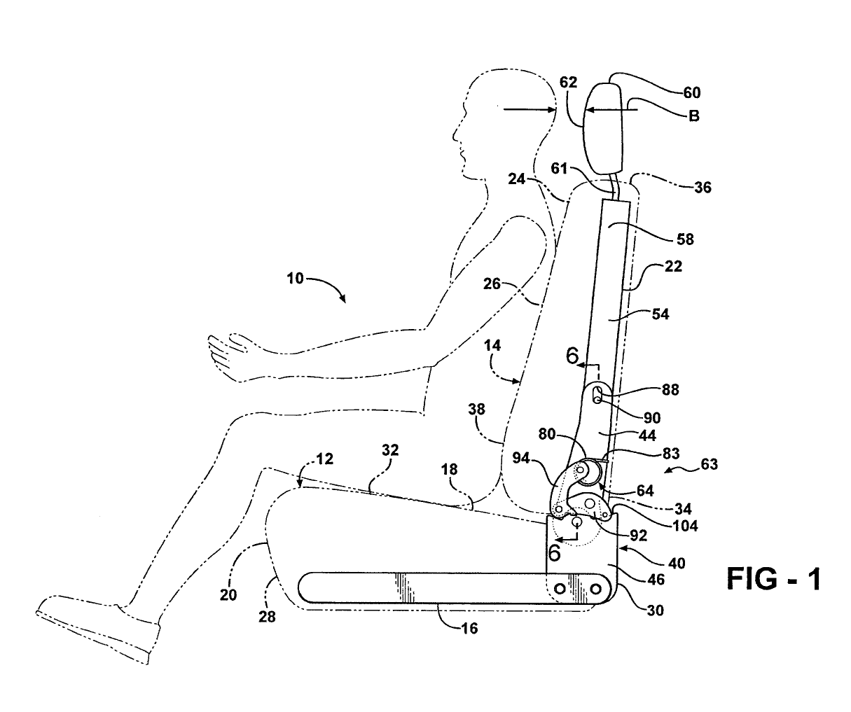

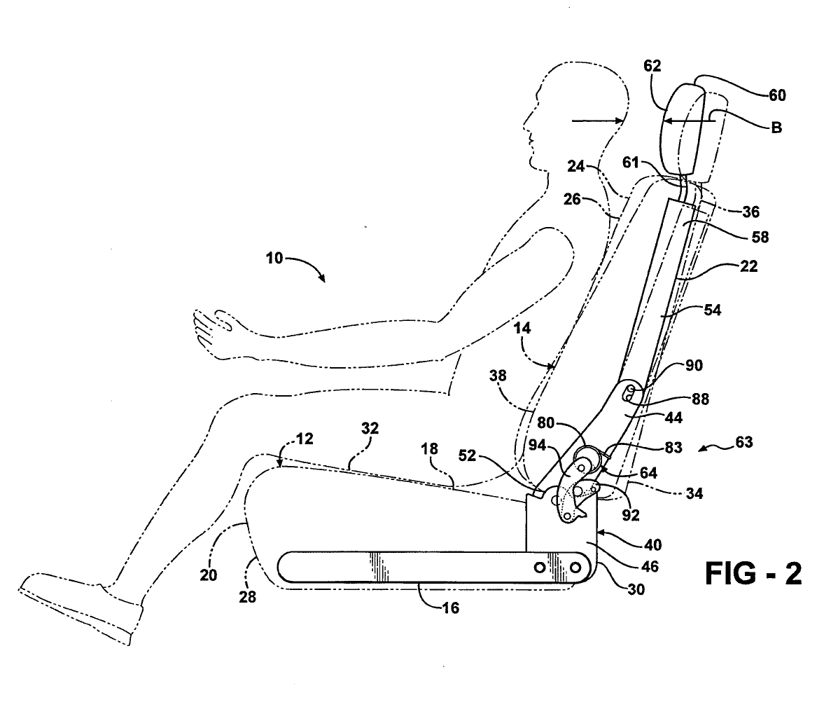

Referring to the Figures, wherein like numerals indicate like or corresponding parts throughout the several views, a seat assembly for use in an automotive vehicle is generally shown at 10 in FIGS. 1 and 2. The seat assembly 10 includes a seat cushion, generally indicated at 12, and a seat back, generally indicated at 14, for supporting an occupant in the vehicle. As is commonly known to one skilled in the art, the seat cushion 12 includes a seat cushion frame 16 supporting a resilient contoured foam pad 18 encased by a trim cover 20 of cloth, leather, vinyl or the like. Similarly, the seat back 14 includes a seat back frame 22 supporting a resilient contoured foam pad 24 encased by a trim cover 26. The seat cushion 12 has opposite and spaced apart front 28 and rear 30 portions and a top supporting surface 32 for supporting the seat occupant. The seat back 14 has opposite and spaced apart lower 34 and upper 36 portions and a front supporting surface 38 for supporting a back of the seat occupant.

The seat assembly 10 also includes a pair of spaced recliner mechanisms, generally indicated at 40, operatively coupling the seat back 14 and seat cushion 12. The recliner mechanisms 40 provide selective pivotal adjustment of the seat back 14 about a first pivot axis 42 relative to the seat cushion 12 between a plurality of reclined seating positions defined generally between an upright seating position, shown in FIG. 1, and a fully reclined seating position, shown in FIG. 2. More specifically, each recliner mechanism 40 includes an upper recliner bracket or A-bracket 44 and a lower recliner bracket or B-bracket 46. The B-bracket 46 is fixedly secured to the seat cushion frame 16. The A-bracket 44 extends between a first end 48 and a second end 50. The first end 48 of each A-bracket 44 is pivotally coupled to the respective B-bracket 46 by a disc recliner 52 of any suitable type well known in the art. The disc recliner 52 controls pivotal movement of the A-bracket 44 relative to the B-bracket 46 about the first pivot axis 42.

The seat back frame 22 of the seat back 14 is operatively coupled to the pair of spaced apart recliner mechanisms 40 as is described below. The seat back frame 22 includes a pair of spaced apart and parallel frame tubes 54. The frame tubes 54 extend between lower and upper ends, thereby defining a lower end 56 of the seat back frame 22 adjacent the lower portion 34 of the seat back 14 and an upper end 58 of the seat back frame 22 adjacent the upper portion 36 of the seat back 14. A head restraint 60 is fixedly secured to the upper end 58 of the seat back frame 22 by a pair of spaced apart posts 61 (one shown) extending therebetween. The head restraint 60 includes a front supporting surface 62 for supporting the seat occupant's head. It is contemplated that the posts 61 may be slidably coupled to the upper end 58 of the seat back frame 22 for providing vertical height adjustment of the head restraint 60 relative to the upper portion 36 of the seat back 14.

With the seat occupant seated in the seat assembly 10, a distance between the back of the seat occupant's head and the front supporting surface 62 of the head restraint 60 is referred to as “backset” and is shown as B in FIGS. 1 and 2. The present invention maintains a predetermined backset distance B as the seat back 14 is pivotally adjusted between the upright seating position, shown in FIG. 1, and the fully reclined seating position, shown in FIG. 2. In the current embodiment the backset distance B is selected to be approximately fifty-five (55) millimeters, however, it is appreciated that the backset distance B could be any of a plurality of distances greater than or less than 55 millimeters.

In order to maintain the backset distance B constant at 55 millimeters as the seat back 14 is pivotally adjusted between the upright seating position and the fully reclined seating position, an adjustment mechanism, generally shown at 63, is provided. The adjustment mechanism 63 automatically adjusts the position of the head restraint 60 in response to pivotal movement of the seat back 14. For example, the head restraint 60 moves toward the back of the seat occupant's head as the seat back 14 pivots rearward toward the fully reclined seating position. Conversely, the head restraint 60 moves away from the back of the seat occupant's head as the seat back 14 pivots forward toward the upright seating position. Because the head restraint 60 is fixedly secured to the upper end 58 of the seat back frame 22, the adjustment of the head restraint 60 toward and away from the seat occupant's head is accomplished by tilting the seat back 14 as the seat back 14 is pivotally adjusted.

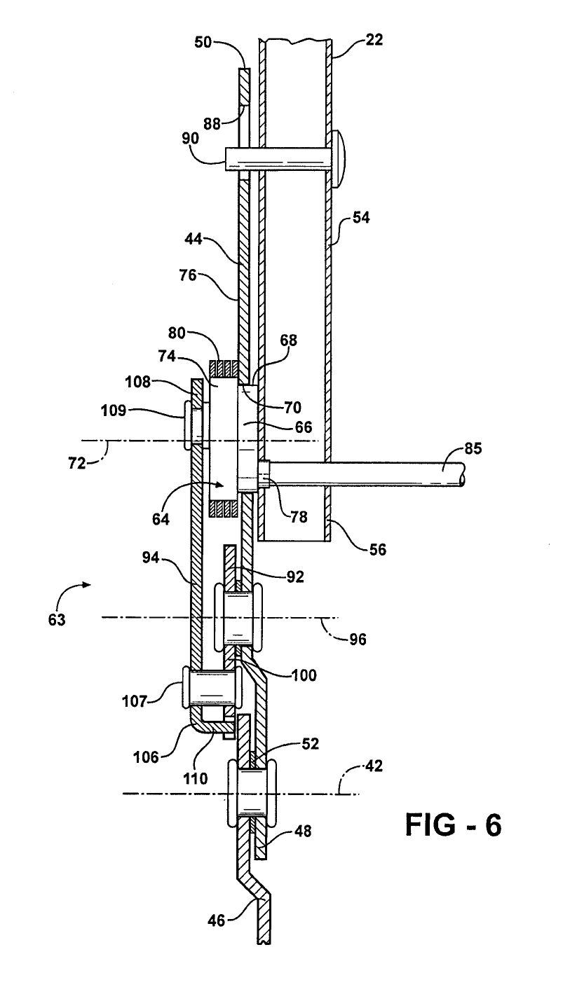

The adjustment mechanism 63 is operatively coupled between the lower end 56 of the seat back frame 22 and the B-brackets 46, as described below in more detail. The adjustment mechanism 63 includes first and second eccentric bearings, generally indicated at 64, 65. In the embodiment shown, the first 64 and second 65 bearings are substantially the same and only the first bearing 64 will described herein in detail. The first bearing 64 includes a first cylindrical portion 66 defining a bearing surface 68 that is disposed in a circular aperture 70 extending through one of the A-brackets 44. The first bearing 64 rotates about a rotation axis 72 that is coincident with the geometric center of the first cylindrical portion 66, as shown in FIG. 6. The first bearing 64 also includes a second cylindrical portion 74 having a larger circumference than the first cylindrical portion 66 and is coaxial therewith. The second cylindrical portion 74 is disposed adjacent to an outer surface 76 of the respective A-bracket 44 to maintain the lateral position of the first bearing 64 relative to the A-bracket 44. The first bearing 64 further includes a cylindrical boss 78 extending from the first cylindrical portion 66 on a side opposite the second cylindrical portion 74. The boss 78 is offset from the rotation axis 72. Therefore, the first bearing 64 is eccentric in that as the first bearing 64 rotates about the rotation axis 72 the boss 78 moves along an arcuate path.

A torsion spring 80 is disposed around the second cylindrical portion 74 of the first bearing 64 and extends between a first end 82 engaging a notch (not shown) in the second cylindrical portion 74 and a second end 83 engaging a notch 84 in the respective A-bracket 44. The torsion spring 80 biases the first bearing 64 in a clockwise direction (when viewed from the Figures).

An axle or shaft 85 is fixedly secured to the cylindrical boss 78 of the first bearing 64 and extends laterally through the lower end 56 of the seat back frame 22, terminating at a distal end 86. The distal end 86 of the axle 85 is fixedly secured to the cylindrical boss 78 of the second bearing 65, which is rotatably disposed in the circular aperture 70 extending through the other one of the A-brackets 44. As the first 64 and second 65 bearings rotate about the rotation axis 72, the axle 85 moves along the arcuate path thereby translating the lower end 56 of the seat back frame 22 relative to the A-brackets 44.

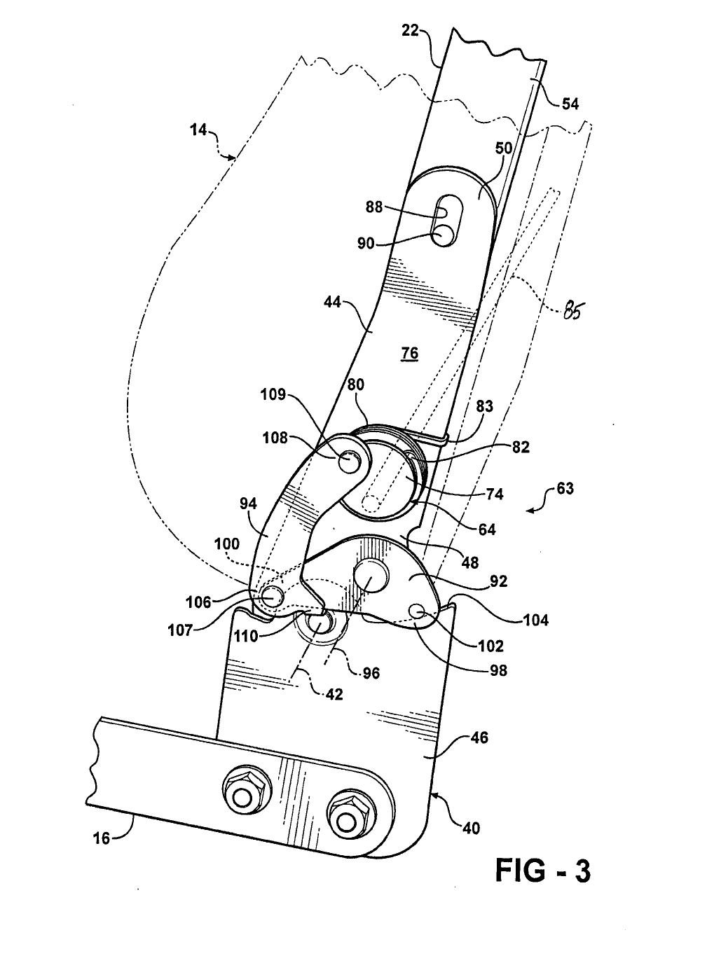

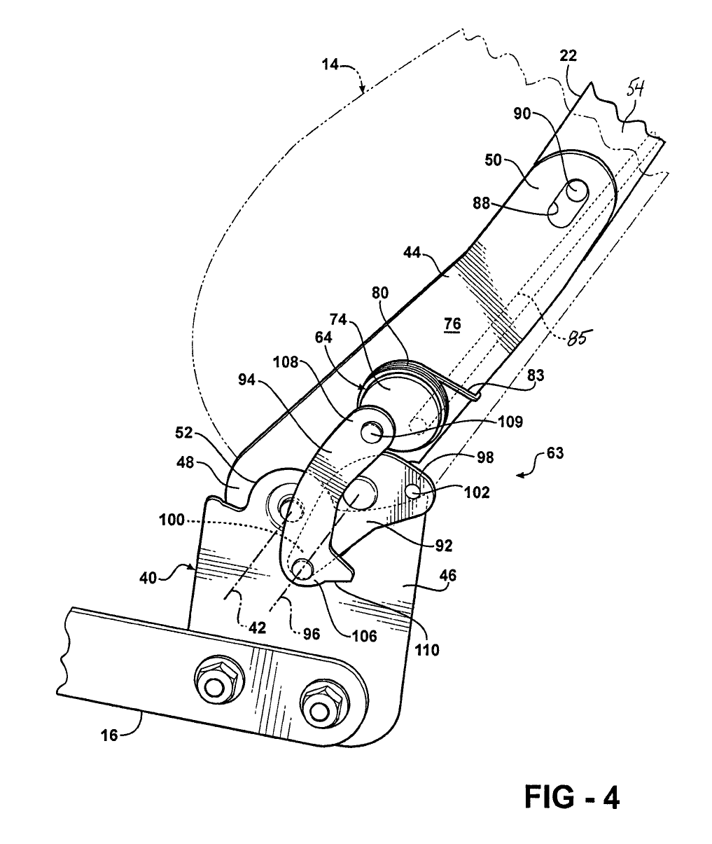

The first 64 and second 65 bearings are oriented within the apertures 70 so that the arcuate path defines a predetermined amount of fore/aft travel. Therefore, as the first 64 and second 65 bearings rotate about the rotation axis 72, the lower end 56 of the seat back frame 22 translates forwardly and rearwardly depending upon the direction of rotation of the bearings 64, 65. In the embodiment shown, rotation of the bearings 64, 65 in a counterclockwise direction (when viewed from FIG. 3) translates the lower end 56 of the seat back frame 22 rearwardly. Conversely, rotation of the bearings 64, 65 in the clockwise direction (when viewed from FIG. 4) translates the lower end 56 of the seat back frame 22 forwardly. As stated above, the torsion spring 80 biases the first bearing 64 in the clockwise direction thereby urging the lower end 56 of the seat back frame 22 forwardly.

The second end 50 of each A-bracket 44 includes a generally vertically extending slot 88 for receiving a pin 90 extending laterally from the respective frame tubes 54 of the seat back frame 22, between the lower 56 and upper 58 ends thereof. The pivotal and sliding connection between the pins 90 and slots 88 allow the seat back frame 22, and therefore the seat back 14, to tilt as the lower end 56 of the seat back frame 22 translates forwardly and rearwardly. More specifically, as the lower end 56 of the seat back frame 22 moves rearwardly due to counterclockwise rotation of the first 64 and second 65 bearings, the pins 90 pivot and slide within the slots 88 to allow the upper end 58 of the seat back frame 22 to tilt forwardly, thus moving the upper portion 36 of the seat back 14 and the head restraint 60 toward the seat occupant's head. Conversely, as the lower end 56 of the seat back frame 22 moves forwardly due to clockwise rotation of the first 64 and second 65 bearings, the pins 90 pivot and slide within the slots 88 to allow the upper end 58 of the seat back frame 22 to tilt rearwardly, thus moving the upper portion 36 of the seat back 14 and the head restraint 60 away from the seat occupant's head. Depending on the desired amount of head restraint movement, various adjustments can be made to the offset between the rotation axis 72 and the cylindrical bosses 78, the orientation of the bearings 64, 65 within the apertures 70, and the location of the slots 88 in the A-brackets 44.

On the same side of the seat assembly 10 as the first bearing 64, the adjustment mechanism 63 also includes first 92 and second 94 links for rotatably actuating the bearings 64, 65. The first link 92 is pivotally coupled to the outer surface 76 of the respective A-bracket 44 about a second pivot axis 96. The first link 92 extends between a follower end 98 and a link end 100. The follower end 98 includes a pin 102 extending laterally therefrom. The pin 102 extends laterally inward, toward the seat assembly, and slidably engages a registry component or guide surface 104 that is integrally formed as part of the respective B-bracket 46. The pin 102 is in contact with the guide surface 104 when the seat back 14 is in the upright seating position, as shown in FIG. 3. As the seat back 14 pivots rearward (clockwise in the Figures) toward the fully reclined seating position, the pin 102 slides along the guide surface 104 which urges the first link 92 to pivot in the counterclockwise direction about the second pivot axis 96.

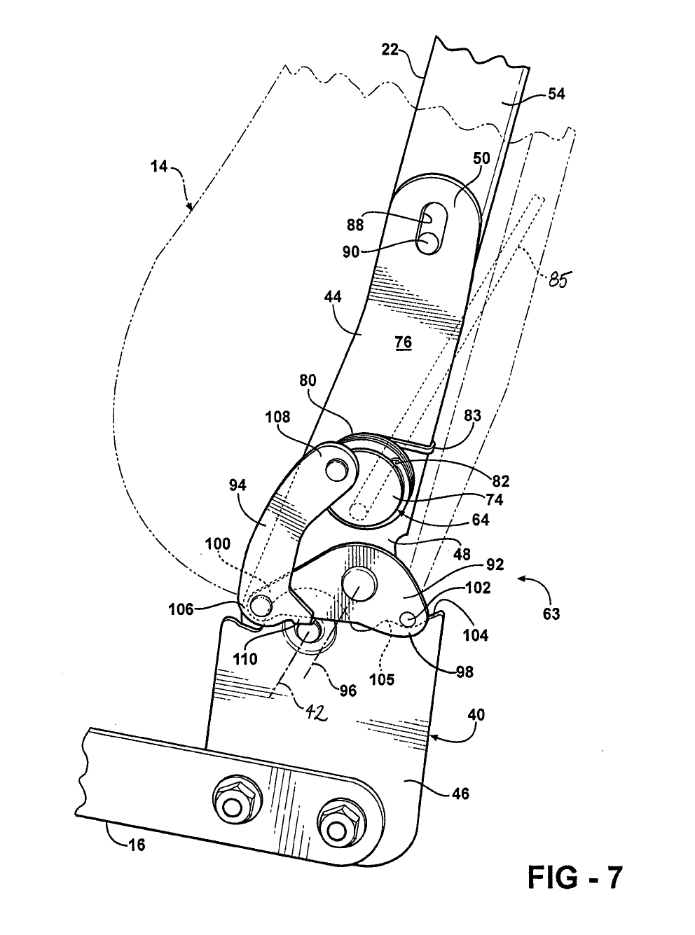

It is appreciated that the guide surface 104 may be formed such that a variety of backset distances B can be achieved. More specifically, the shape of the guide surface 104 may be any linear or non-linear shape and may include a convex portion 105, such as that shown in FIG. 7, so as to provide a continually varying backset distance B as desired to optimize occupant comfort.

The second link 94 extends between a first end 106 pivotally coupled to the link end 100 of the first link 92 at pivot 107 and a second end 108 pivotally coupled to the second cylindrical portion 74 of the first bearing 64 at pivot 109. The pivotal connection 109 between the second link 94 and the first bearing 64 is offset from the rotational axis 72. The second link 94 causes the first bearing 64 to rotate in response to pivotal movement of the first link 92. When the seat back 14 is pivotally adjusted rearward toward the fully reclined seating position, the first link 92 pivots in the counterclockwise direction as described above, and the link end 100 of the first link 92 pulls the second link 94 downwardly causing the first bearing 64 to rotate in the counterclockwise direction. Conversely, when the seat back 14 is pivotally adjusted forward toward the upright seating position, the torsion spring 80 urges the first bearing 64 to rotate in the clockwise direction pulling the second link 94 upwardly thereby causing the first link 92 to pivot in the clockwise direction. The first end 106 of the second link 94 includes a tab 110 projecting inwardly which abuts an edge of the first link 92 when the seat back 14 is in the upright seating position to stop the clockwise rotation of the first bearing 64.

In operation, the backset distance B of the head restraint 60 remains constant as the seat back 14 is pivotally adjusted. As the seat back 14 is pivotally adjusted rearward from the upright seating position, shown in FIG. 1, to one of the plurality of reclined seating positions (i.e., toward the fully reclined seating position shown in FIG. 2), the head restraint 60 moves toward the seat occupant's head. Specifically, when the disc recliners 52 are actuated to adjust, or pivot the seat back 14 rearward, the A-brackets 44 pivot in the clockwise direction about the first pivot axis 42. As the A-brackets 44 pivot in the clockwise direction, the guide surface 104 urges the first link 92 to pivot in the counterclockwise direction about the second pivot axis 96 thereby pulling the second link 94 downwardly and causing the first bearing 64 to rotate in the counterclockwise direction about the rotation axis 72. Through the axle 85, the second bearing 65 rotates in the same direction as the first bearing 64. The counterclockwise rotation of the first 64 and second 65 bearings translates the axle 85, and therefore the lower end 56 of the seat back frame 22, rearwardly along the arcuate path. As the lower end 56 translates rearwardly, the seat back frame 22 tilts and the upper end 58 translates forwardly, thereby moving the upper portion 36 of the seat back 14 and the head restraint 60 toward the seat occupant's head.

The opposite movement of the head restraint 60 occurs when the seat back 14 is pivotally adjusted forward. As the seat back 14 is pivotally adjusted forward to return to the upright seating position, shown in FIG. 1, the head restraint 60 moves away from the seat occupant's head. Specifically, when the disc recliners 52 are actuated to adjust, or pivot the seat back 14 forward, the A-brackets 44 pivot in the counterclockwise direction about the first pivot axis 42. As the A-brackets 44 pivot in the counterclockwise direction, the torsion spring 80 urges the first bearing 64 to rotate in the clockwise direction thereby pulling the second link 94 upwardly and causing the first link 92 to pivot in the clockwise direction about the second pivot axis 96. Through the axle 85, the second bearing 65 rotates in the same direction as the first bearing 64. The clockwise rotation of the first 64 and second 65 bearings translates the axle 85, and therefore the lower end 56 of the seat back frame 22, forwardly along the arcuate path. As the lower end 56 translates forwardly, the seat back frame 22 tilts and the upper end 58 translates rearwardly, thereby moving the upper portion 36 of the seat back 14 and the head restraint 60 away from the seat occupant's head. Therefore, the adjustment mechanism 63 automatically adjusts the position of the head restraint 60 relative to the seat occupant's head, in response to pivotal movement of the seat back 14.

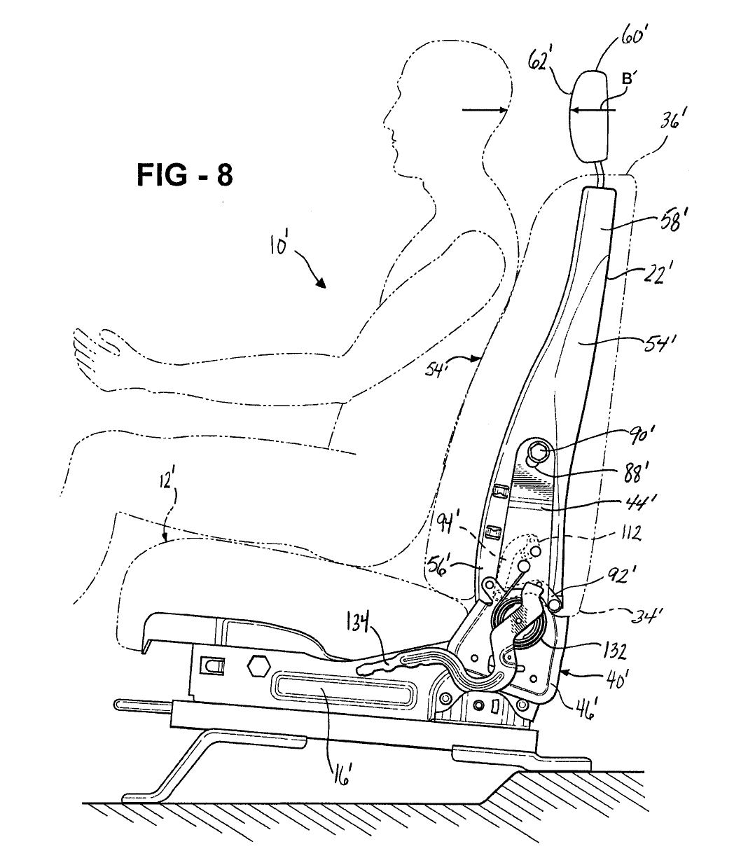

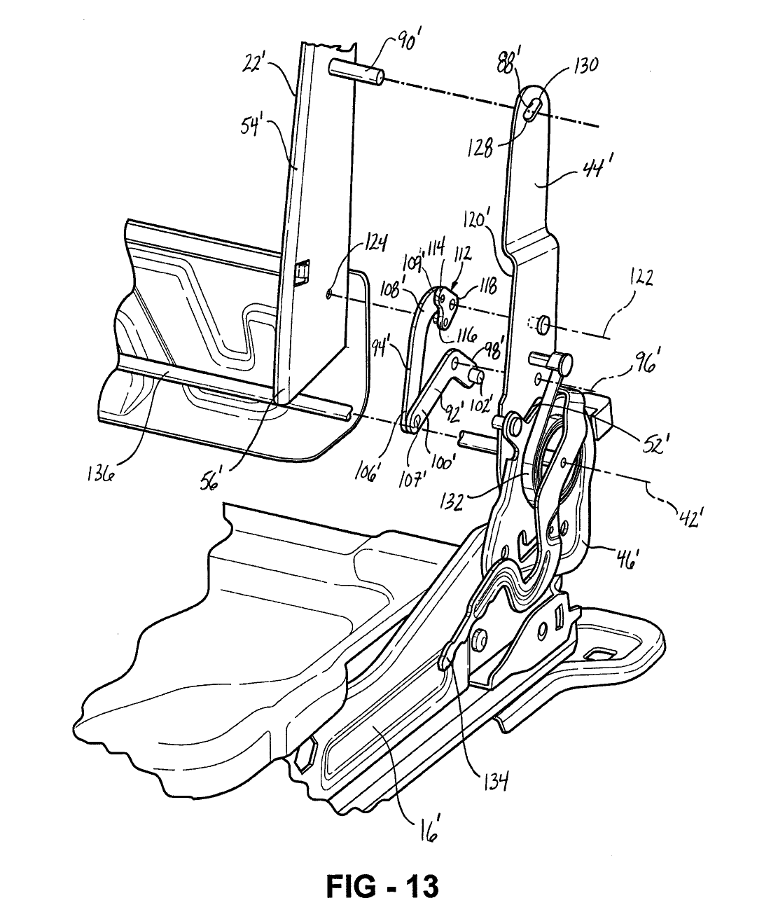

Referring to FIGS. 8 through 13, wherein like primed reference numerals represent similar elements as those described above, in a second embodiment of the invention the first 64 and second 65 eccentric bearings are each replaced with a generally V-shaped link 112 (one shown), hereinafter referred to as a V-link. Each V-link 112 is disposed between one of the A-brackets 44′ and the corresponding frame tube 54′ of the seat back frame 22′. The V-link 112 includes a first arm 114, a second arm 116, and a middle portion 118. The middle portion 118 is rotatably coupled to an inner surface 120 of the respective A-bracket 44′ about a rotation axis 122. The second arm 116 is pivotally coupled to the corresponding frame tube 54′ of the seat back frame 22′ at pivot 124, between the lower 56′ and upper 58′ ends thereof. As the V-link 112 rotates about the rotation axis 122, the second arm 116 moves the pivot 124 along the arcuate path thereby translating the lower end 56′ of the seat back frame 22′ relative to the A-brackets 44′.

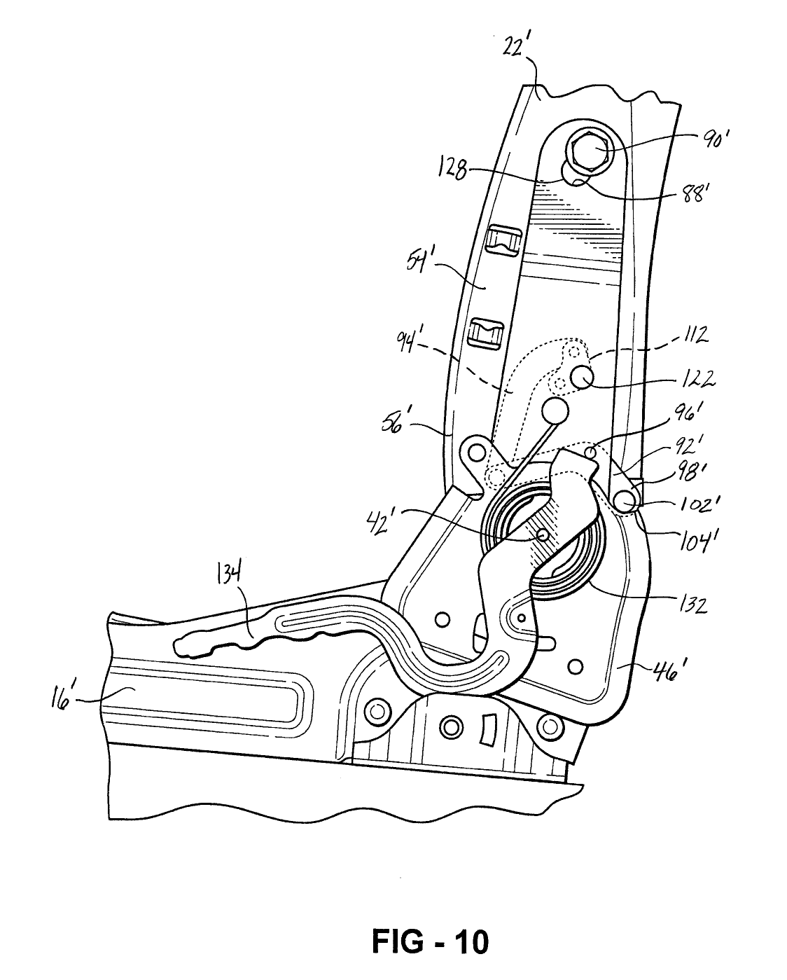

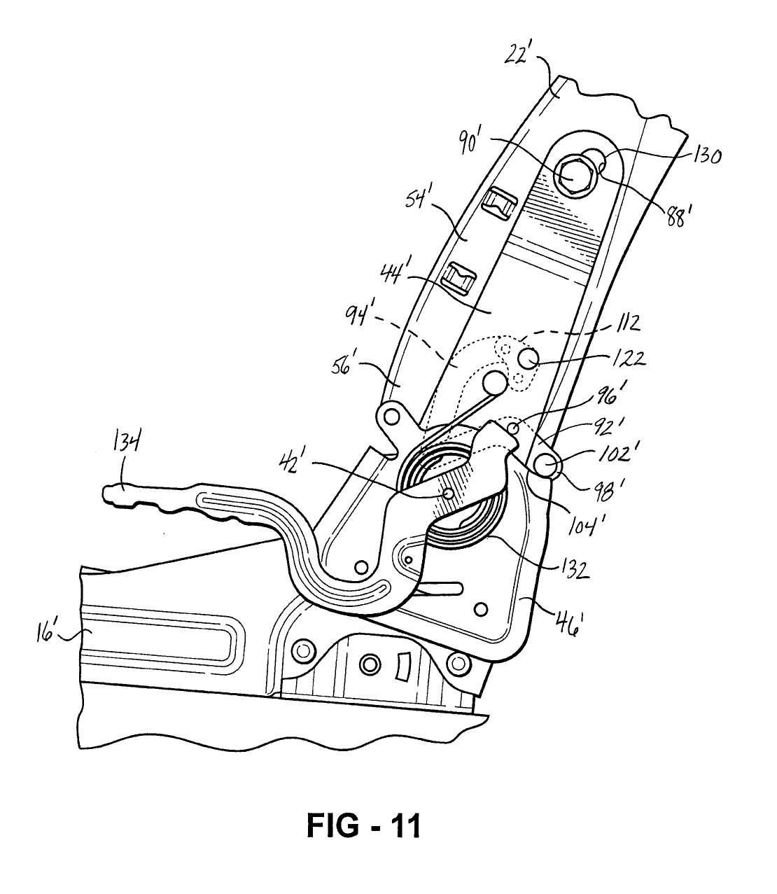

The V-link 112 is oriented so that the arcuate path defines a predetermined amount of fore/aft travel. Therefore, as the V-link 112 rotates about the rotation axis 122, the lower end 56′ of the seat back frame 22′ translates forwardly and rearwardly depending upon the direction of rotation of the V-link 112. In the embodiment shown, rotation of the V-link 112 in the counterclockwise direction (when viewed from FIG. 10) translates the lower end 56′ of the seat back frame 22′ rearwardly. Conversely, rotation of the V-link 112 in the clockwise direction (when viewed from FIG. 11) translates the lower end 56′ of the seat back frame 22′ forwardly.

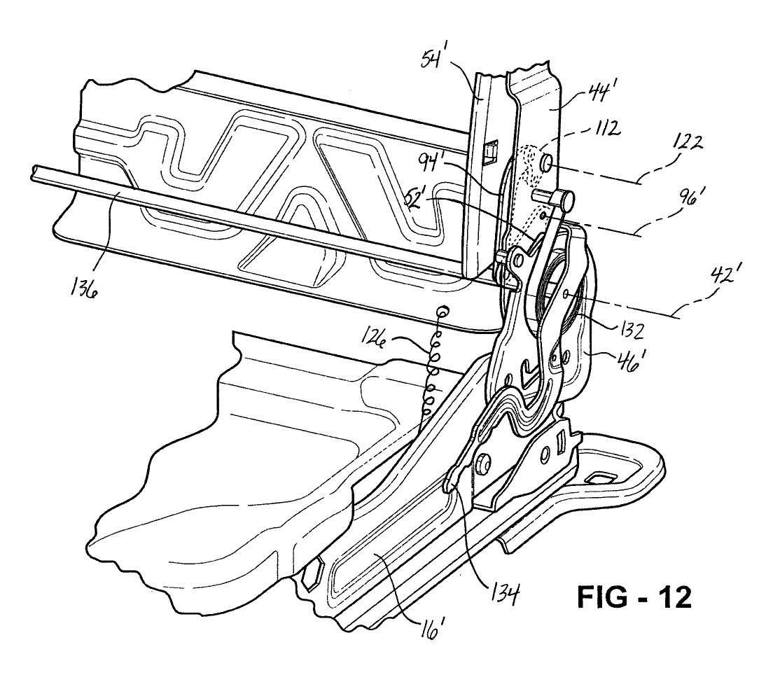

Referring to FIG. 12, a pair of extension springs 126 (one shown) extend between the lower end 56′ of the seat back frame 22′and the seat cushion frame 16′. The extension springs 126 bias the lower end 56′ of the seat back frame 22′ forwardly. It is appreciated that, in the alternative, a torsion spring (not shown) may be used to bias the V-link 112 in the clockwise direction, thereby urging the lower end 56′ of the seat back frame 22′ forwardly.

The slot 88′ at the second end 50′ of each A-bracket 44′ extends between a lower first end 128 and an upper second end 130. In the embodiment shown, the upper second end 130 of the slot 88′ is disposed generally rearward of the lower first end 128. When the seat back 14′ is in the upright seating position the pin 90′ is disposed at the upper second end 130 of the slot 88′, as shown in FIG. 10. When the seat back 14′ is in the fully reclined seating position the pin 90′ is disposed at the lower first end 128 of the slot 88′, as shown in FIG. 11.

The V-link 112 is operatively coupled to the B-bracket 46′ by a linkage including the first 92′ and second 94′ links. The first link 92′ is pivotally coupled to the inner surface 120 of the A-bracket 44′ about the second pivotal axis 96′. The follower end 98′ of the first link 92′ includes the pin 102′ extending laterally therefrom. The pin 102′ extends laterally away from the seat assembly 10′ and slidably engages the guide surface 104′ that is integrally formed as part of the respective B-bracket 46′. The pin 102′ is in contact with the guide surface 104′ when the seat back 14′ is in the upright seating position, as shown in FIG. 10. As the seat back 14′ pivots rearward (clockwise in the Figures) toward the fully reclined seating position, the pin 102′ slides along the guide surface 104′ which urges the first link 92′ to pivot in the counterclockwise direction about the second pivot axis 96′.

Referring to FIGS. 10 and 11, it can be seen that the guide surface 104′ is sloped in a direction opposite to that of the guide surface 104, shown in FIG. 3, with respect to the first embodiment. It is appreciated, however, that the guide surface 104′ of the second embodiment may be any linear or non-linear shape without varying from the scope of the invention.

The second link 94′ pivotally connects the first link 92′ and the V-link 112. More specifically, the first end 106′ of the second link 94′ is pivotally coupled to the link end 100′ of the first link 92′ at pivot 107′ and the second end 108′ is pivotally coupled to the first arm 114 of the V-link 112 at pivot 109′. The second link 94′ causes the V-link 112 to rotate in response to pivotal movement of the first link 92′. When the seat back 14′ is pivotally adjusted rearward toward the fully reclined seating position, the first link 92′ pivots in the counterclockwise direction as described above, thereby pulling the second link 94′ downwardly, which in turn causes the V-link 112 to rotate in the counterclockwise direction. Conversely, when the seat back 14′ is pivotally adjusted forward toward the upright seating position, the extension springs 126 bias the lower end 56′ of the seat back frame 22′ forwardly, which urges the V-link 112 to rotate in the clockwise direction, which in turn pulls the second link 94′ upwardly and causes the first link 92′ to pivot in the clockwise direction.

The seat assembly 10′ also includes at least one torsion spring 132 for biasing the seat back 14′ toward the upright seating position and a recliner handle 134 for actuating the disc recliners 52′ between locked and unlocked states, as is well known in the art. More particularly, the torsion spring 132 is disposed about the first pivot axis 42′ and extends between the A-bracket 44′ and the B-bracket 46′ to urge the A-bracket 44′ to pivot in the counterclockwise direction about the first axis 42′ relative to the B-bracket 46′. The recliner handle 134 is operatively coupled to one of the disc recliners 52′ for actuation thereof. A cross-talk tube 136 extends between the disc recliners 52′ for simultaneous actuation of both in response to operation of the recliner handle 134.

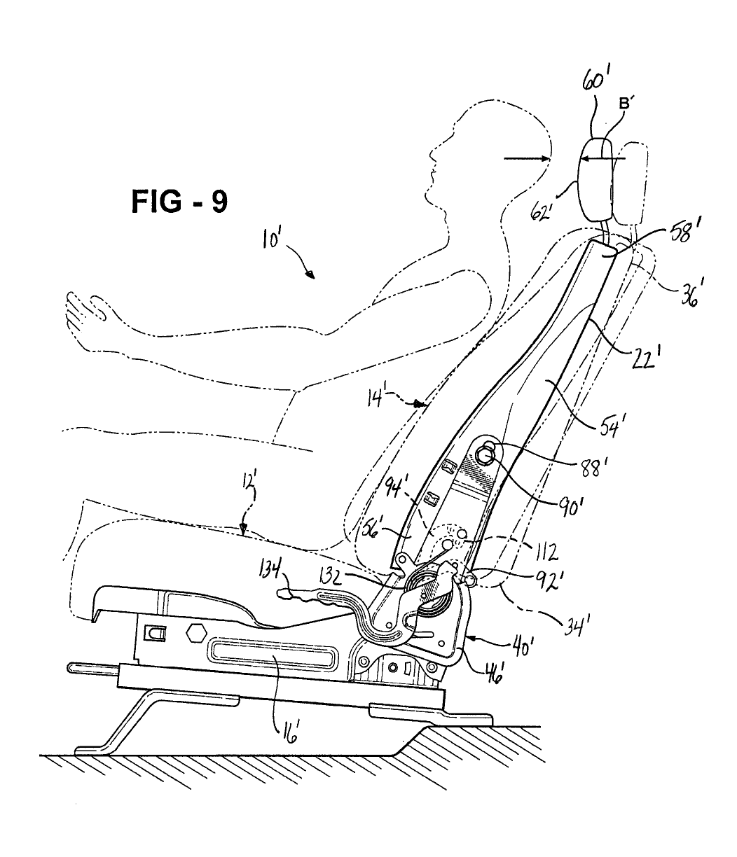

In operation, the backset distance B′ of the head restraint 60′ remains constant as the seat back 14′ is pivotally adjusted. As the seat back 14′ is pivotally adjusted rearward from the upright seating position, shown in FIG. 8, to one of the plurality of reclined seating positions (i.e., toward the fully reclined seating position shown in FIG. 9), the head restraint 60′ moves toward the seat occupant's head. Specifically, when the disc recliners 52′ are actuated to adjust, or pivot the seat back 14′ rearward, the A-brackets 44′ pivot in the clockwise direction about the first pivot axis 42′. As the A-brackets 44′ pivot in the clockwise direction, the guide surface 104′ urges the first link 92′ to pivot in the counterclockwise direction about the second pivot axis 96′ thereby pulling the second link 94′ downwardly and causing the V-link 112 to rotate in the counterclockwise direction about the rotation axis 122. The counterclockwise rotation of the V-link 112 translates the lower end 56′ of the seat back frame 22′ rearwardly along the arcuate path. As the lower end 56′ translates rearwardly, the seat back frame 22′ tilts and the upper end 58′ translates forwardly, thereby moving the upper portion 36′ of the seat back 14′ and the head restraint 60′ toward the seat occupant's head until the pins 90′ reach the lower first end 128 of the slots 88′.

The opposite movement of the head restraint 60′ occurs when the seat back 14′ is pivotally adjusted forward. As the seat back 14′ is pivotally adjusted forward to return to the upright seating position, shown in FIG. 8, the head restraint 60′ moves away from the seat occupant's head. Specifically, when the disc recliners 52′ are actuated to adjust, or pivot the seat back 14′ forward, the torsion spring 132 biases the A-brackets 44′ to pivot in the counterclockwise direction about the first pivot axis 42′. At the same time, the extension springs 126 urge the lower end 56′ of the seat back frame 22′ forwardly along the arcuate path thereby causing the V-link 112 to rotate in the clockwise direction. Clockwise rotation of the V-link 112 pulls the second link 94′ upwardly, which causes the first link 92′ to pivot in the clockwise direction about the second pivot axis 96′. As the lower end 56′ translates forwardly, the seat back frame 22′ tilts and the upper end 58′ translates rearwardly, thereby moving the upper portion 36′ of the seat back 14′ and the head restraint 60′ away from the seat occupant's head until the pins 90′ reach the upper second end 130 of the slots 88′. Therefore, the adjustment mechanism 63′ automatically adjusts the position of the head restraint 60′ relative to the seat occupant's head, in response to pivotal movement of the seat back 14′.

The invention has been described here in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. A seat assembly for supporting a seat occupant in an automotive vehicle, said seat assembly comprising:
a seat cushion;
a seat back operatively coupled to said seat cushion for selective pivotal movement between a plurality of reclined seating positions, said seat back including a seat back frame;
a head restraint coupled to said seat back frame, said head restraint including a front supporting surface defining a backset distance between said front supporting surface and the seat occupant's head; and
an adjustment mechanism operatively interconnecting said seat back frame and said seat cushion for automatically tilting said seat back in response to said pivotal movement of said seat back to maintain said backset distance constant, wherein said seat back tilts forward thereby moving said front supporting surface of said head restraint toward the seat occupant's head as said seat back pivots rearward and said seat back tilts rearward thereby moving said front supporting surface of said head restraint away from the seat occupant's head as said seat back pivots forward.

2. A seat assembly as set forth in claim 1 wherein said seat back frame extends between an upper end and a lower end, and wherein said head restraint is coupled to said upper end of said seat back frame.

3. A seat assembly as set forth in claim 2 wherein said seat assembly includes a pair of spaced apart recliner mechanisms, each of said recliner mechanisms including an upper recliner bracket pivotally coupled to a lower recliner bracket.

4. A seat assembly as set forth in claim 3 wherein said upper recliner bracket is operatively coupled to said seat back and pivotally coupled to said lower recliner bracket, and wherein said lower recliner bracket is coupled to said seat cushion.

5. A seat assembly as set forth in claim 4 wherein said upper recliner bracket extends between a first end pivotally coupled to said lower recliner bracket and a second end including a slot extending therethrough.

6. A seat assembly as set forth in claim 5 wherein said seat back frame includes a first pin fixedly secured thereto between said upper and lower ends, said first pin disposed in said slot thereby pivotally and slidably coupling said seat back frame and said upper recliner bracket.

7. A seat assembly as set forth in claim 6 further including a first eccentric bearing operatively coupled between said seat back frame and said seat cushion for urging said lower end of said seat back frame along an arcuate path in response to said pivotal movement of said seat back.

8. A seat assembly as set forth in claim 7 wherein said first eccentric bearing is rotatably disposed in a first aperture in a first upper recliner bracket between said first and second ends thereof, said first eccentric bearing defining a rotation axis, and wherein rotation of said first eccentric bearing about said rotation axis translates said lower end of said seat back frame along said arcuate path.

9. A seat assembly as set forth in claim 8 wherein said first eccentric bearing rotates in a first direction to translate said lower end of said seat back frame rearwardly along said arcuate path and said first eccentric bearing rotates in a second direction to translate said lower end of said seat back frame forwardly along said arcuate path.

10. A seat assembly as set forth in claim 9 wherein said first eccentric bearing is connected to said lower end of said seat back frame, said connection between said first eccentric bearing and said lower end of said seat back frame offset from said rotation axis.

11. A seat assembly as set forth in claim 10 further including a biasing means for urging said first eccentric bearing to rotate in said second direction.

12. A seat assembly as set forth in claim 11 wherein said biasing means is a torsion spring extending between said first eccentric bearing and said first upper recliner bracket.

13. A seat assembly as set forth in claim 12 further including a first link pivotally coupled to said first upper recliner bracket and operatively engaging a first lower recliner bracket, a second link pivotally coupled between said first link and said first eccentric bearing, whereby pivoting said seat back rearward causes said first link to pivot in a first direction causing said second link to rotate said first eccentric bearing in said first direction thereby translating said lower end of said seat back frame rearwardly along said arcuate path, and whereby said spring causes said first eccentric bearing to rotate in said second direction thereby translating said lower end of said seat back frame forwardly along said arcuate path in response to pivoting said seat back forward.

14. A seat assembly as set forth in claim 13 wherein said first link extends between a follower end engaging a guide surface of said first lower recliner bracket and a link end, and said second link extends between a first end pivotally coupled to said link end of said first link and a second end pivotally coupled to said first eccentric bearing defining a pivotal connection.

15. A seat assembly as set forth in claim 14 wherein said pivotal connection between said second end of said second link and said first eccentric bearing is offset from said rotation axis.

16. A seat assembly as set forth in claim 15 wherein said follower end of said first link includes a second pin extending laterally therefrom, said second pin slidably engaging said guide surface of said first lower recliner bracket.

17. A seat assembly as set forth in claim 16 wherein said first end of said second link includes a tab for abutting said first link when said seat back is in an upright seating position thereby preventing further rotation of said first eccentric bearing in said second direction.

18. A seat assembly as set forth in claim 17 further including a second eccentric bearing rotatably disposed in a second aperture in a second upper recliner bracket between said first and second ends thereof, a rotation axis of said second eccentric bearing coaxial with said rotation axis of said first eccentric bearing.

19. A seat assembly as set forth in claim 18 wherein said first and second eccentric bearings are coupled together by an axle extending therebetween, said axle fixedly secured to said lower end of said seat back frame.

20. A seat assembly as set forth in claim 6 further including a V-shaped link operatively coupled between said seat back frame and said seat cushion for urging said lower end of said seat back frame along an arcuate path in response to said pivotal movement of said seat back.

21. A seat assembly as set forth in claim 20 wherein said V-shaped link includes a first arm and a second arm, said V-shaped link rotatably coupled between said first and second arms to a first upper recliner bracket between said first and second ends thereof defining a rotation axis, and wherein rotation of said V-shaped link about said rotation axis translates said lower end of said seat back frame along said arcuate path.

22. A seat assembly as set forth in claim 21 wherein said V-shaped link rotates in a first direction to translate said lower end of said seat back frame rearwardly along said arcuate path and said V-shaped link rotates in a second direction to translate said lower end of said seat back frame forwardly along said arcuate path.

23. A seat assembly as set forth in claim 22 wherein said second arm of said V-shaped link is pivotally coupled to said lower end of said seat back frame.

24. A seat assembly as set forth in claim 23 further including a biasing means for urging said V-shaped link to rotate in said second direction.

25. A seat assembly as set forth in claim 24 further including a first link pivotally coupled to said first upper recliner bracket and operatively engaging a first lower recliner bracket, a second link pivotally coupled between said first link and said first arm of said V-shaped link, whereby pivoting said seat back rearward causes said first link to pivot in a first direction causing said second link to rotate said V-shaped link in said first direction thereby translating said lower end of said seat back frame rearwardly along said arcuate path, and whereby said biasing means causes said first V-shaped link to rotate in said second direction thereby translating said lower end of said seat back frame forwardly along said arcuate path in response to pivoting said seat back forward.

26. A seat assembly as set forth in claim 25 wherein said first link extends between a follower end engaging a guide surface of said first lower recliner bracket and a link end, and said second link extends between a first end pivotally coupled to said link end of said first link and a second end pivotally coupled to said first arm of said V-shaped link.

27. A seat assembly as set forth in claim 26 wherein said follower end of said first link includes a second pin extending laterally therefrom, said second pin slidably engaging said guide surface of said first lower recliner bracket.

28. A seat assembly as set forth in claim 27 wherein said biasing means is an extension spring extending between said lower end of said seat back frame and said seat cushion.

29. A seat assembly for supporting a seat occupant in an automotive vehicle, said seat assembly comprising:
a seat cushion;
a seat back operatively coupled to said seat cushion for selective pivotal movement between a plurality of reclined seating positions about a first transverse axis;
a head restraint coupled to said seat back; and
an adjustment mechanism operatively interconnecting said seat back and said seat cushion, said adjustment mechanism tilting said seat back in response to said pivotal movement of said seat back.

30. A seat assembly as set forth in claim 29 wherein said seat back tilts to move said head restraint toward and away from the seat occupant's head as said seat back pivots rearward and forward respectively.
